(19) United States
(12) Patent Application Publication
(10) Pub. No.: US 2012/0168516 A1
(43) Pub. Date: Jul. 5, 2012

(54) RFID TRANSPONDER ENCAPSULATION FOR MOBILE ELECTRONIC DEVICE COVERS

(76) Inventors: Walker Bolger, Arlington, VA (US); Chetan Karani, Chantilly, VA (US); Patrick J. Sweeney, II, Ashburn, VA (US)

(21) Appl. No.: 13/306,361

(22) Filed: Nov. 29, 2011

Related U.S. Application Data
(60) Provisional application No. 61/417,623, filed on Nov. 29, 2010.

(51) Int. Cl. G06K 19/077

(52) U.S. Cl. 235/492

(57) ABSTRACT

An RFID transponder encapsulated in a dielectric substrate can be integrated, connected, or attached to and used in conjunction with a mobile electronic device cover. The RFID transponder and dielectric substrate can then be encased between the mobile electronic device cover and the mobile electronic device.

### CROSS-REFERENCE TO RELATED APPLICATIONS

This application claims priority to and the benefit of U.S. Provisional Application No. 61/417,623, filed Nov. 29, 2010, the disclosure of which is incorporated herein by reference in its entirety.

### BACKGROUND

At least one embodiment described herein relates to the field of passive radio frequency identification (RFID) transponder encapsulation. More specifically, the encapsulation of RFID transponders specific for use on, within, connected, or integrated with mobile electronic device covers (or cases) is described.

Known radio frequency identification (RFID) transponders can be used with RFID readers and other devices to identify or track objects. In some instances, it may be helpful to track a cell phone or other mobile electronic device to determine the location of a user but these devices rarely come equipped with RFID transponders or readers. The known cases (or sleeves) that cover and/or protect these devices also do not come equipped with RFID transponders or readers. However, cases can be swapped out and replaced more easily and for less cost than replacing a cell phone or like mobile electronic device. Thus, what is needed is a case with an RFID transponder that can be coupled to and operate with a cell phone or other mobile electronic device post-manufacture so that the device user can be identified and/or tracked for various purposes.

### SUMMARY

In one embodiment, a RFID transponder is encapsulated for use in conjunction with synthetic mobile electronic covers (or cases) where the cover (or case) partially or fully encloses or encases a mobile electronic device therein, encasing the RFID transponder between the cover (or case) and the mobile electronic device.

### BRIEF DESCRIPTION OF THE DRAWINGS

FIG. 1 is an exploded view of a mobile electronic device assembly comprising a mobile electronic device, a mobile electronic device cover (or case) an RFID transponder, and a substrate, according to an embodiment.

FIG. 2 is a rear view of the mobile electronic device cover shown in FIG. 1 where the RFID transponder shown in FIG. 1 is in shadow.

FIG. 3 is a rear perspective view of the mobile electronic device cover shown in FIG. 2 enclosing the mobile electronic device shown in FIG. 1.

### DETAILED DESCRIPTION OF THE INVENTION

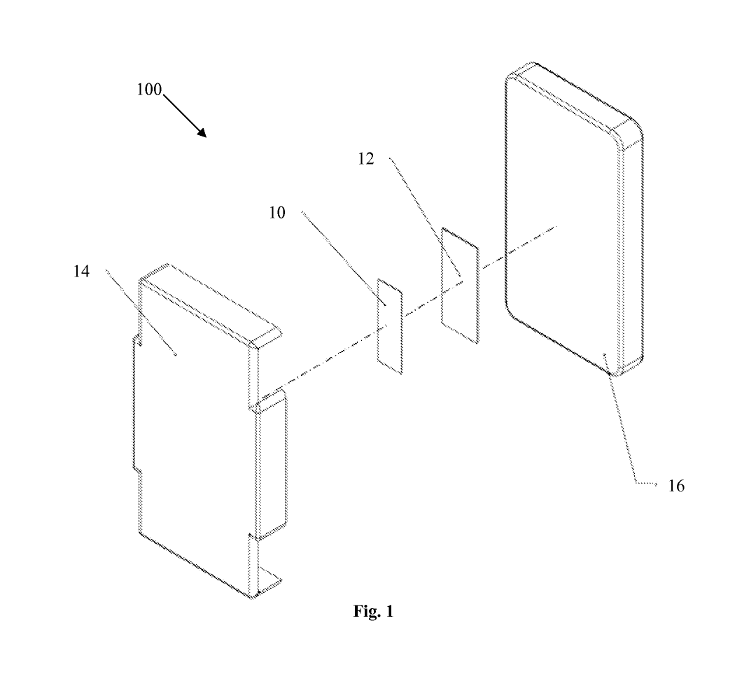

FIG. 1 is an exploded view of a mobile electronic device assembly 100. The mobile electronic device assembly 100 includes a mobile electronic device 16, a mobile electronic device cover 14, a RFID transponder 10, and a dielectric substrate 12. The mobile electronic device 16 can be, for example, a cellular phone, a personal digital assistant (PDA) and/or the like. The RFID transponder 10 can be coupled to the dielectric substrate 12. The combined RFID transponder 10 and the dielectric substrate 12 can be integrated or connected to the mobile electronic device cover 14. The mobile electronic device cover 14 can then be attached to the mobile electronic device 16 to form the mobile electronic device assembly 100.

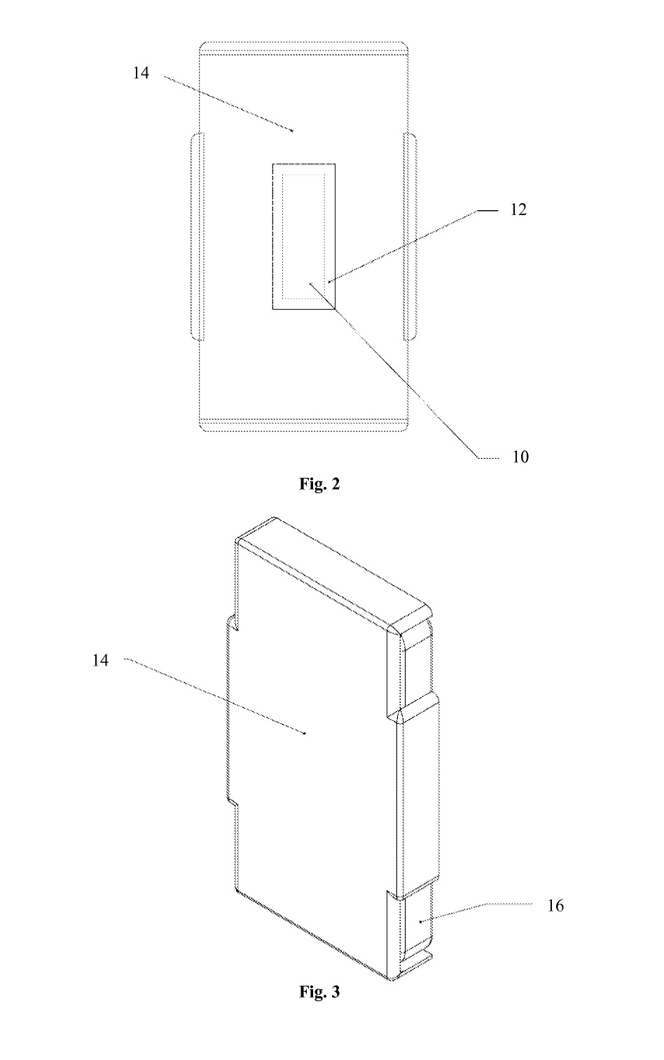

FIG. 2, for example, is a rear view of the RFID transponder 10 and dielectric substrate 12 (in shadow) attached to the mobile electronic device cover 14. As discussed in more detail below, the RFID transponder 10 and dielectric substrate 12 can be attached to the mobile electronic device cover 14 in any manner. In some embodiments, the RFID transponder 10 and dielectric substrate 12 are not easily removed from the mobile electronic device cover 14. In some such embodiments, the RFID transponder 10, dielectric substrate 12 and the mobile electronic device cover 14 collectively form a single unit that attaches to and detaches from the mobile electronic device 16.

FIG. 3 is a rear view of the mobile electronic device cover 14 attached to and encasing (or enclosing) the mobile electronic device 16. In this particular embodiment, the RFID transponder 10 and dielectric substrate 12 are encased between the mobile electronic device cover 14 and the mobile electronic device 16. The RFID transponder 10 and dielectric substrate 12 can be manufactured to have a thickness small enough so that the mobile electronic device cover 14 can attach to the mobile electronic device 16 without physical obstruction or electromagnetic interference from the RFID transponder 10 and/or dielectric substrate 12.

When the mobile electronic device cover 14 is attached to the mobile electronic device 16, the RFID transponder 10 can be activated and/or used for a variety of applications. For example, in some embodiments, the RFID transponder 10 can be used for location-based marketing. A user can, for example, register the RFID transponder 10 and/or the mobile electronic device cover 14 with a service (or network) such that the RFID transponder 10 and/or the mobile electronic device cover 14 can be tracked and/or identified at certain locations. In one example, the user can walk into a registered restaurant (or café or store) with his or her cell phone (having the mobile electronic device cover 14 attached) and an RFID reader at the restaurant can communicate with the RFID transponder 10 to identify the user. In other words, the RFID reader has an operational range that includes the restaurant. Once the user is within the operational range of the RFID reader then the RFID transponder 10 can communicate with the RFID reader (e.g., the RFID transponder 10 can transmit a signal to the RFID reader and/or receive a signal from the RFID reader). In some instances, the restaurant (or café or store) can automatically send a coupon to the user's cell phone (e.g., via text message or email) when the RFID reader at the restaurant identifies the user based on the RFID transponder 10. In some instances, the restaurant (or café or store), service and/or network can issue points to the user for dining at the registered restaurant. The restaurant (or café or store) could also send affinity points and recognize the client for visiting the store.

The RFID transponder 10 can also be used for social media purposes. For example, the RFID transponder 10 can be read by an RFID reader at a specific location (e.g., when the RFID transponder 10 is within the operational range of the RFID reader) or the RFID transponder 10 can include or be connected to an electrical circuit or device that can determine the location of the user and send location information to, for example, the user's cell phone, which can access the internet and post the user's location on a social media site or network based on that location information. The RFID transponder 10 and/or the electrical circuit or device can be electrically connected to the mobile electronic device 16 such that the RFID transponder 10 and/or the electrical circuit or device communicates with the mobile electronic device 16 via wireless communication, wired communication, and/or the like. In some embodiments, the RFID transponder 10 and/or the electrical circuit or device determines the location of the user based on one or more RFID readers at a location (e.g., within an operating range). Using the above restaurant example, the RFID transponder 10 and/or the electrical circuit or device can determine that the user is at that particular restaurant when the RFID reader at that restaurant initiates or otherwise communicates with the RFID transponder 10. In some embodiments, the RFID reader at the restaurant can send location information to the user's cell phone via wireless communication, wired communication, and/or the like. In other embodiments, the RFID reader at the location of the restaurant or store can virtually “check a person in” on a social media site letting a user's personal social network know that they are at a specific location. In this manner, the RFID transponder 10 need not include an electrical circuit or device.

In other embodiments, the RFID transponder 10 can be used for safety purposes. For example, the user can have an RFID reader in his or her car that communicates with the RFID transponder 10. If, for example, the user is driving the car, the RFID transponder 10 can facilitate in disabling one or more features of the user's cell phone (e.g., texting and/or email) so that the user is not distracted by the one or more features while she is driving. For example, in some embodiments, the RFID transponder 10 transmits or sends a signal to the user's cell phone that causes or otherwise results in one or more features of the user's cell phone being disabled. In some embodiments, the RFID transponder 10 can communicate with the cell phone (i.e., the mobile electronic device 16) via wireless communication, wired communication or the like. In some embodiments, the RFID transponder 10 includes or is connected to an electrical circuit or device that communicates with the cell phone to disable the one or more features based on information provided from the RFID transponder 10 or the RFID reader in the car. In other embodiments, the RFID reader in the car, after communicating with the RFID transponder 10, communicates with the cell phone to disable the one or more features.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

The RFID transponder 10 can be any suitable RFID transponder such as, for example, a passive RFID tag, an active RFID tag, or a battery assisted passive (BAP) RFID tag. In some embodiments, the RFID transponder 10 can include one or more electrical circuits or devices that provide additional functionality. In some embodiments, the RFID transponder 10 can be configured to communicate with any number of devices such as, for example, an RFID reader, a computer, the mobile electronic device 16, other RFID transponders and/or the like. The RFID transponder 10 can have any number of components and, in some embodiments, the mobile electronic device assembly can include more than one RFID transponder 10. Additionally, the RFID transponder 10 can have any suitable shape and/or size. For example, as shown in FIG. 1, the RFID transponder 10 has a rectangular shape and is substantially smaller than the mobile electronic device cover 14.

The mobile electronic device cover 14 can be constructed from any suitable material such as, for example, metal, plastic, rubber, and/or the like. The mobile electronic device cover 14 can be flexible, rigid or some combination thereof. In some embodiments, the mobile electronic device cover 14 can be removeably attached to the mobile electronic device 16. For example, the mobile electronic device cover 14 can snap onto the mobile electronic device 16, slide into the mobile electronic device 16, be pulled onto the mobile electronic device 16 (e.g., if the mobile electronic device cover 14 is substantially flexible), and/or the like. In some embodiments, however, the mobile electronic device cover 14 can be integrated into the mobile electronic device 16 such that the mobile electronic device cover 14 is part of the mobile electronic device 16. For example, in some embodiments, the mobile electronic device cover 14 can be a portion of the housing of the mobile electronic device 16.

The RFID transponder 10 can be coupled to the dielectric substrate 12 in any suitable manner. For example, the RFID transponder 10 (or at least a portion of the RFID transponder 10) can be formed on, connected to and/or integrated with the dielectric substrate 12. In some embodiments, the RFID transponder 10 and the dielectric substrate 12 are disposed within a single device such that the single device is connected to the mobile electronic device cover 14. In some embodiments, however, the mobile electronic device assembly does not include the dielectric substrate 12.

The RFID transponder 10 and/or the dielectric substrate 12 can be connected to the mobile electronic device cover 14 in any suitable manner. For example, the RFID transponder 10 and/or the dielectric substrate 12 can be attached to the mobile electronic device cover 14 via an adhesive bonding, a mechanical bonding, soldering, and/or the like. In some embodiments, the RFID transponder 10 and/or the dielectric substrate 12 is coupled to the outer surface (not identified) of the mobile electronic device cover 14 such that the mobile electronic device cover 14 separates the RFID transponder 10 and/or the dielectric substrate 12 from the mobile electronic device 16. In some embodiments, the RFID transponder 10 and/or the dielectric substrate 12 is embedded within the mobile electronic device cover 14.

In other embodiments, the RFID transponder 10 and/or the dielectric substrate 12 is coupled to the inner surface (not identified) of the mobile electronic device cover 14 such that at least a portion of the RFID transponder 10 and/or the dielectric substrate 12 contacts the mobile electronic device 16 when the mobile electronic device cover 14 is attached to the mobile electronic device 16. In instances where the dielectric substrate 12 is disposed between the RFID transponder 10 and the mobile electronic device 16, the dielectric substrate 12 can provide an offset between the RFID transponder 10 and the mobile electronic device 16 to reduce the effects of physical interference on the RFID transponder 10 performance such as read rates and read range interference source(s) in the mobile electronic device 16 such as metallic surfaces or magnetic fields produced by electric currents.

Although various embodiments have been described as having particular features and/or combinations of components, other embodiments are possible having a combination of any features and/or components from any of embodiments where appropriate.

What is claimed is:

1. An apparatus, comprising:
an electronic device cover configured to be removeably attached to a first electronic device; and
a radio frequency identification (RFID) transponder fixedly coupled to the electronic device cover, the RFID transponder configured to transmit a signal to a second electronic device such that location information associated with a user of the first electronic device is acquired when the electronic device cover is attached to the first electronic device.

2. The apparatus of claim 1, wherein the electronic device cover is configured to encase at least a portion of the first electronic device when the electronic device cover is attached to the first electronic device.

3. The apparatus of claim 1, wherein the RFID transponder is fixedly coupled to an inner surface of the electronic device cover such that the RFID transponder is disposed between the electronic device cover and the first electronic device when the electronic device cover is attached to the first electronic device.

4. The apparatus of claim 1, wherein the RFID transponder is fixedly coupled to an outer surface of the electronic device cover such that the electronic device cover is disposed between the RFID and the first electronic device when the electronic device cover is attached to the first electronic device.

5. The apparatus of claim 1, wherein at least a portion of the RFID transponder is embedded within the electronic device cover.

6. The apparatus of claim 1, wherein the second electronic device is an RFID reader having an operational range, the user of the first electronic device being in the operational range when the RFID transponder transmits the signal to the second electronic device.

7. The apparatus of claim 1, wherein the RFID transponder is activated when the electronic device cover is attached to the first electronic device such that the RFID transponder is configured to transmit a signal to the first electronic device, the RFID transponder being deactivated when the electronic device cover is detached from the first electronic device such that the RFID transponder does not transmit a signal to the first electronic device.

8. The apparatus of claim 1, wherein the RFID transponder is configured to transmit a signal to the first electronic device such that one or more functions of the first electronic device are disabled based on the location information when the electronic device cover is attached to the first electronic device.

9. The apparatus of claim 1, wherein the electronic device cover is removeably attached to the first electronic device such that the electronic device cover at least one of (a) snaps onto the first electronic device, (b) slides onto the first electronic device, or (c) is pulled onto the first electronic device.

10. The apparatus of claim 1, wherein the RFID transponder is coupled to a substrate that is fixedly coupled to the electronic device cover.

11. An apparatus, comprising:
an electronic device cover configured to be removeably coupled to an electronic device; and
a radio frequency identification (RFID) transponder fixedly coupled to the electronic device cover, the RFID transponder configured to transmit a signal to a first RFID reader having a first operational range when a user of the electronic device is within the first operational range and the electronic device cover is coupled to the electronic device, the electronic device configured to receive data associated with the first operational range after the RFID transponder transmits the signal to the first RFID reader,
the RFID transponder configured to transmit a signal to a second RFID reader having a second operational range different from the first operational range when the user of the electronic device is within the second operational range and the electronic device cover is coupled to the electronic device, the electronic device configured to receive data associated with the second operational range after the RFID transponder transmits the signal to the second RFID reader.

12. The apparatus of claim 11, wherein the first operational range includes a restaurant and the data associated with the first operational range is a coupon for the restaurant.

13. The apparatus of claim 11, wherein the RFID transponder is configured to transmit the data associated with the first operational range to the electronic device when the user of the electronic device is within the first operational range and the electronic device cover is coupled to the electronic device, the RFID transponder not transmitting the data associated with the first operational range to the electronic device when the electronic device cover is decoupled from the electronic device.

14. The apparatus of claim 11, wherein the RFID transponder is one of a plurality of RFID transponders fixedly coupled to the electronic device cover.

15. The apparatus of claim 11, wherein the RFID transponder is one of a passive RFID tag, an active RFID tag, or a battery-assisted passive RFID tag.

16. The apparatus of claim 11, wherein the electronic device cover is removeably attached to the electronic device such that the electronic device cover at least one of (a) snaps onto the electronic device, (b) slides onto the electronic device, or (c) is pulled onto the electronic device.

17. The apparatus of claim 11, wherein the RFID transponder is fixedly coupled to an inner surface of the electronic device cover such that the RFID transponder is disposed between the electronic device cover and the electronic device when the electronic device cover is attached to the electronic device.

18. The apparatus of claim 17, wherein the RFID transponder is sized such that the electronic device cover couples to the electronic device without physical obstruction or electromagnetic interference from the RFID transponder.

19. An apparatus, comprising:
an electronic device cover configured to be removeably coupled to a mobile electronic device, the electronic device cover having a substrate embedded therein; and
a radio frequency identification (RFID) transponder coupled to the substrate of the electronic device cover, the RFID transponder configured to determine a location of a user of the mobile electronic device and to transmit location information to the mobile electronic device when the electrical device cover is coupled to the mobile electronic device.

20. The apparatus of claim 19, wherein the RFID transponder includes an electrical circuit configured to determine the location of the user of the mobile electronic device.
